(19) United States
(12) Patent Application Publication
(10) Pub. No.: US 2013/0222291 A1
(43) Pub. Date: Aug. 29, 2013

(54) TOUCHSCREEN AND ELECTRONIC DEVICE USING SAME

(71) Applicants: Fu Tai Hua Industry (Shenzhen) Co., Ltd., (US); Hon Hai Precision Industry Co., Ltd., (US)

(72) Inventor: QIANG YOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/721,079

(22) Filed: Dec. 20, 2012

(30) Foreign Application Priority Data
Feb. 27, 2012 (CN) 201210045376.5

(51) Int. Cl. G06F 3/041

(52) U.S. Cl. CPC G06F 3/041
USPC 345/173

(57) ABSTRACT

A touchscreen for an electronic device includes an input surface, a number of temperature sensors, and a processor connected to the temperature sensors. The temperature sensors senses temperatures of positions on the input surface and outputs corresponding sensing signals to the processor. The processor receives the sensing signals and determines whether the input surface is touched based on the sensing signals.

### BACKGROUND

1. Technical Field

The present disclosure relates to touch technology, especially to a touchscreen and an electronic device using the touchscreen.

2. Description of Related Art

As portable electronic devices become more widely used, a user-friendly, simplified and convenient operation of an input device is increasingly important. Touchscreen input devices can handily meet many of such demands.

A commonly used touchscreen is a capacitive touchscreen. However, due to interference from environmental temperatures, a dielectric capacitance of a capacitor formed between the touchscreen and a human body is liable to become not constant when the environmental temperature changes a lot. As a result, contact coordinates calculated by the touchscreen are apt to be inaccurate. Accordingly, stability of the touchscreen may be influenced. As a result, quality of the portable electronic device employing the touchscreen may deteriorate, and enjoyment of the portable electronic device may be diminished.

What is needed, therefore is a touchscreen and an electronic device using the touchscreen that can overcome the aforementioned problems.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the various views.

FIG. 1 is a schematic structural view of a first embodiment of an electronic device including a touchscreen and a display device.

FIG. 2 is a schematic structural view of the touchscreen of FIG. 1.

FIG. 3 is a schematic block view of the display device of FIG. 1.

FIG. 4 is a schematic structural view of a second embodiment of an electronic device.

### DETAILED DESCRIPTION

Reference will be made to the drawings to describe specific exemplary embodiments of the present disclosure.

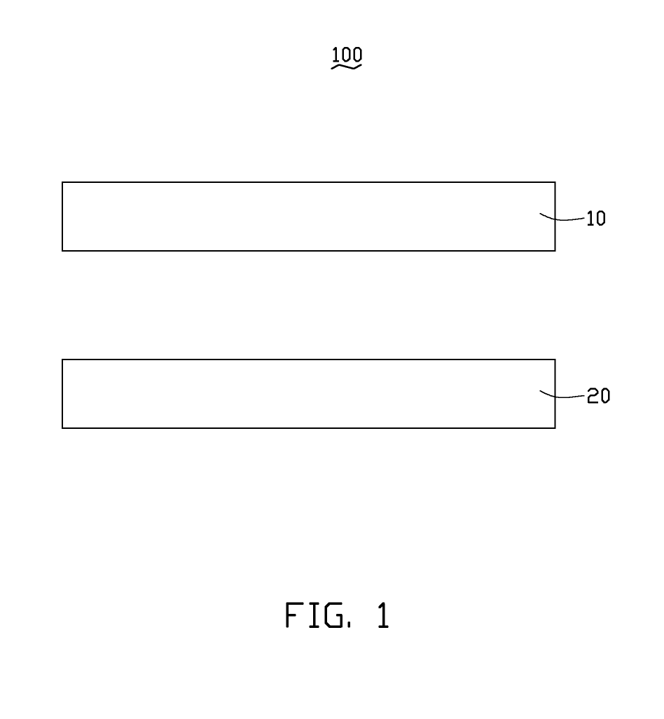

FIG. 1 shows an electronic device 100 according to a first embodiment of the present disclosure. In the first embodiment, the electronic device 100 includes a touchscreen 10 and a display device 20. In the present embodiment, the touchscreen 10 is positioned near a display surface (not labeled) of the display device 20. The touchscreen 10 may be used as an input interface for user operations. The touchscreen 10 detects contact positions on the touchscreen 10 corresponding to the user operations and outputs positional coordinates of the contact positions to the display device 20. The display device 20 receives the positional coordinates and performs corresponding functions, such as, playing video, acting as a telephone, for example. The display device 20 may be any electronic device which having a display function.

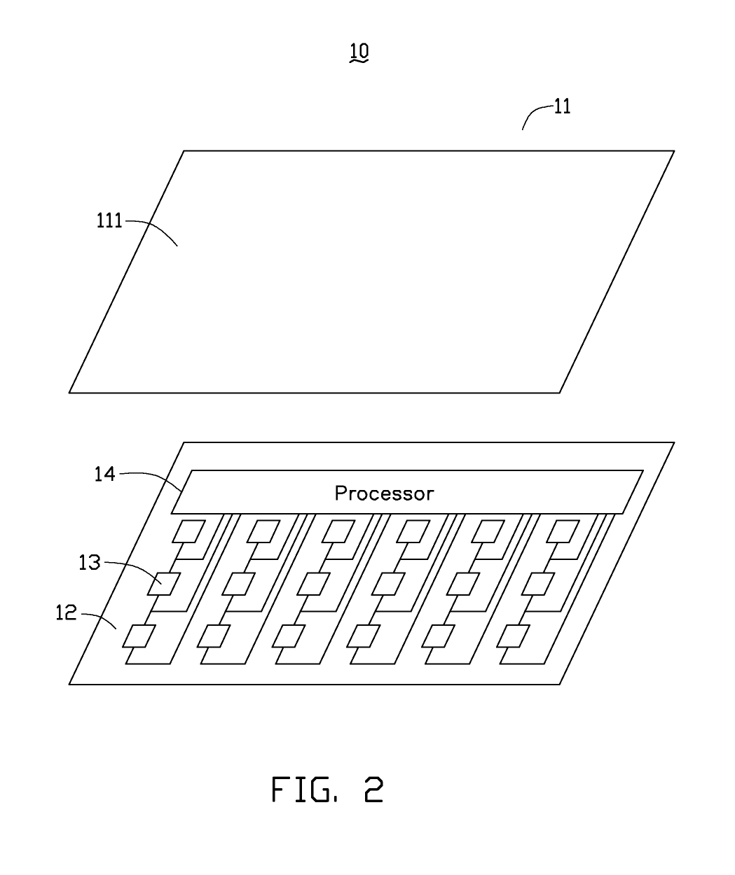

Referring to FIG. 2, a schematic structural view of the touchscreen 10 is shown. The touchscreen 10 includes a protective film 11, a substrate 12, a plurality of temperature sensors 13, and a processor 14. The protective film 11 and the substrate 12 are both either transparent or substantially transparent. The protective film 11 opposes the substrate 12. The temperature sensors 13 and the processor 14 are positioned on the substrate 12 and are located between the protective film 11 and the substrate 12. The temperature sensors 13 are connected to the processor 14. The protective film 11 protects the temperature sensors 13 and the processor 14. A surface 111 of the protective film 11 that faces away from the temperature sensors 13 and the processer 14 is used as an input interface for receiving a direct touch from the finger of a user. The temperature sensors 13 sense temperature changes corresponding to each position on the protective film 11 and outputs corresponding sensing signals to the processor 14. The sensing signals may be currents or voltages, for example. The processor 14 receives the sensing signals from the temperature sensors 13, calculates the positional coordinates of the contact positions based on the sensing signals, and outputs the positional coordinates to the display device 20. The display device 20 receives the positional coordinates, and performs corresponding functions. In the present embodiment, the temperature sensors 13 may be thermal resistors or digital temperature sensors, for example.

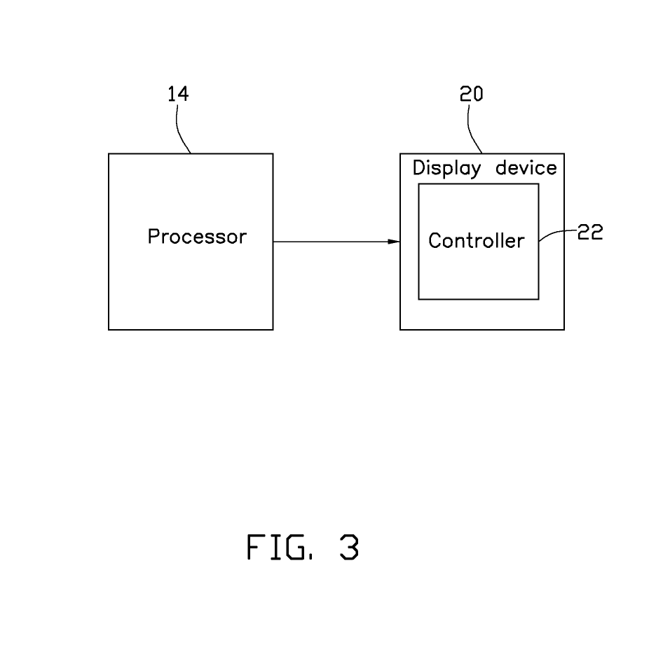

FIG. 3 is a schematic block view of the display device 20. The display device 20 includes a controller 22. The controller 22 is connected to the processor 14, receives the positional coordinates, and controls the display device 20 to perform corresponding functions based on the positional coordinates from the processor 14.

Operation of the electronic device 100 is as follows.

When the touchscreen 10 is not being touched, the temperatures corresponding to each position on the protective film 11 are substantially identical. Correspondingly, the sensing signals that are output to the processor 14 from the temperature sensors 13 are substantially identical. The processor 14 determines that the touchscreen 10 is not being touched based on the substantially identical sensing signals, and does not output any positional coordinates to the controller 22 of the display device 20.

When the touchscreen 10 is being touched, the temperatures corresponding to the contact positions on the protective film 11 may differ from the temperatures corresponding to noncontact positions on the protective film 11. Correspondingly, the sensing signals output from the temperature sensors 13 corresponding to the contact positions differ from the sensing signals output from the temperature sensors 13 without corresponding to the contact positions. The processor 14 receives the sensing signals from all the temperature sensors 13, calculates the positional coordinates of the contact positions based on the sensing signals from all the temperature sensors 13, and outputs the calculated positional coordinates to the controller 22. The controller 22 receives the positional coordinates from the processor 14 and controls the display device 20 to perform corresponding functions based on the positional coordinates.

As described, if the temperature sensors 13 sense temperature change, the sensing signals output from the temperature sensors 13 are relatively more accurate even though an environmental temperature of the display device 20 changes a lot. Accordingly, the contact positions calculated by the touchscreen 10 employing the temperature sensors 13 are relatively more accurate. Therefore, the stability of the touchscreen 10 is much better. As a result, the quality of the electronic device 100 employing the touchscreen 10 possesses higher reliability.

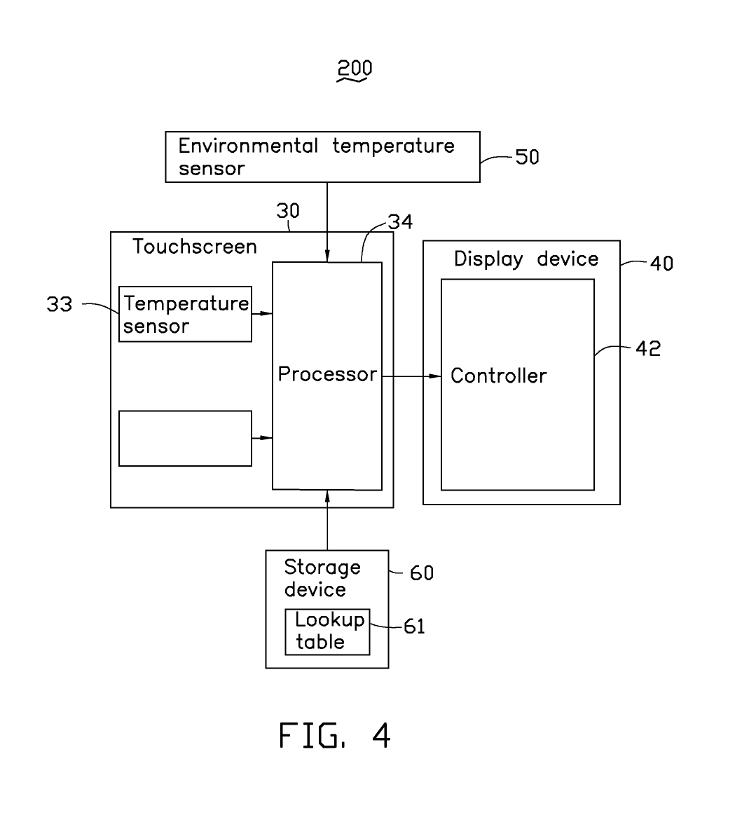

FIG. 4 shows an electronic device 200 according to a second embodiment of the present disclosure. The electronic device 200 includes a touchscreen 30, a display device 40, an environmental temperature sensor 50, and a storage device 60. The touchscreen 30 includes a plurality of temperature sensors 33 and a processor 34 connected to the temperature sensors 33. The environmental temperature sensor 50 is connected to the processor 34, and is configured to detect environmental temperatures, and outputs a corresponding detecting signal to the processor 34. The detecting signal may be a current value or a voltage, for example. The environmental temperature sensor 50 is exposed out from a surface (not shown) of the electronic device 200. The display device 40 includes a controller 42 connected to the processor 34. The storage device 60 is connected to the processor 14 and includes a lookup table 61. The lookup table 61 contains a plurality of reference value ranges that have no range overlap with each other and a plurality of threshold value ranges that have a one to one correspondence with the plurality of reference value ranges. The reference value ranges are representative of environmental temperature ranges. The threshold value ranges are representative of temperature ranges of the contact positions on the touchscreen 30, which are measured at corresponding environmental temperature ranges. The reference value ranges and the threshold value ranges are premeasured and then stored in the storage device 60 when the electronic device 200 is manufactured.

Take an environmental temperature range 5° C. to 7° C. as an example, sensing signals received by the processor 34 from the temperature sensors 33 have little difference from each other at the environmental range 5° C. to 7° C., but have a relatively large difference from other sensing signals measured at other environmental temperature ranges. In addition, contamination of undesired signals, such as, electromagnetic waves, to the sensing signals need to be taken into consideration, and the threshold value range corresponding to the environmental temperature range 5° C. to 7° C. is acquired via the premeasurement. Similarly, other threshold value ranges and corresponding reference value ranges are acquired. In fact, for different electronic device 200, the reference value ranges and the threshold value ranges stored in the lookup table 61 may vary. Further, the environmental temperature ranges each can be divided into smaller ranges to improve the precision of the touchscreen 30.

The operation of the electronic device 200 is as follows.

The environmental temperature sensor 50 detects a current environmental temperature and outputs a corresponding detecting signal to the processor 34. When the processor 34 determines that one or more sensing signals differ from other sensing signals, the processor 34 searches the lookup table 61, finds the reference value range containing the detecting signal. In addition, accesses the threshold value range corresponding to the reference value range containing the detecting signal. The processor 34 further determines whether the one or more sensing signals are within the accessed threshold value range. When the processor 34 determines that one of the one or more sensing signals is within the accessed threshold value range, the processor 34 determines that the input surface is touched. In addition, the processor 34 calculates positional coordinates of a contact position on the touchscreen 10 corresponding to the temperature sensor 33 outputting the sensing signal within the accessed threshold value range and outputs the positional coordinates to the controller 42 of the display device 40. The controller 42 controls the display device 20 to perform corresponding functions based on the positional coordinates. The processor 34 does not calculate and output any positional coordinates when the processor 34 determines that there is no sensing signal within the accessed threshold value range.

As described, since the electronic device 200 stores the threshold value ranges corresponding to different environment temperature ranges that are premeasured, the processor 34 determines whether the sensing signals are within the threshold value range corresponding to the current environmental temperature and acquires whether the touchscreen 30 is actually being touched. Accordingly, the precision of the touchscreen 30 is improved. As a result, quality of the electronic device 100 employing the touchscreen 10 possesses higher reliability.

In alternative embodiments, the threshold value ranges each may be a difference value range. A difference value is acquired by a sensing signal output by a temperature sensor 33 corresponding to a contact position minus a sensing signal output by a temperature sensor 33 corresponding to a noncontact position, for example. If the processor 34 determines that one or more sensing signals differ from other sensing signals. The processor 34 calculates one or more difference values of the one or more sensing signals minus one of the other sensing signals, searches the lookup table 61, and finds the threshold value range corresponding to the reference value range containing the detecting signal of the environmental temperature sensor 50. The processor 34 further determines whether the calculated one or more difference values are within the reference value range containing the detecting signal. If the processor 34 determines that one of the calculated one or more difference values is within the accessed threshold value range, the processer 34 calculates positional coordinates of a contact position corresponding to the temperature sensor 33 which outputs the sensing signal, which minus one of other sensing signals acquires the difference value within the accessed threshold value range. In addition, outputs the positional coordinates to the controller 42 of the display device 40.

In alternative embodiments, the touchscreen 10 and the touchscreen 30 may be incorporated into the display device 20.

In alternative embodiments, the touchscreen 30 includes the environmental temperature sensor 50.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A touchscreen, comprising:
an input surface;
a plurality of temperature sensors sensing temperatures of positions on the input surface and outputting corresponding sensing signals; and
a processor connected to the temperature sensors, receiving the sensing signals, and determining whether the input surface is touched based on the sensing signals.

2. The touchscreen of claim 1, wherein when the processor determines that the input surface is touched, the processor further calculates positional coordinates of a contact position on the input surface.

3. The touchscreen of claim 2, wherein when the processor determines that one or more sensing signals differ from other sensing signals, the processor determines that the input surface is touched and calculates positional coordinates of one or more contact positions on the input surface corresponding to the temperature sensors outputting the one or more sensing signals.

4. The touchscreen of claim 2, further comprising a storage device connected to the processor and an environmental temperature sensor connected to the processor, wherein the environmental temperature sensor detects a current environmental temperature and outputs a corresponding detecting signal to the processor, the storage device stores a lookup table, the lookup table containing a plurality of reference value ranges that have no range overlap with each other and a plurality of threshold value ranges that have a one to one correspondence with the plurality of reference value ranges.

5. The touchscreen of claim 4, wherein when the processor determines that one or more sensing signals differ from the other sensing signals, the processor searches the lookup table, finds the reference value range containing the detecting signal of the environmental temperature sensor, and accesses the threshold value range corresponding to the reference value range containing the detecting signal, the processor further determines whether the one or more sensing signals are within the accessed threshold value range.

6. The touchscreen of claim 5, wherein when the processor determines that one of the one or more sensing signals is within the accessed threshold value range, the processor determines that the input surface is touched and calculates positional coordinates of a contact position on the input surface corresponding to the temperature sensor outputting the sensing signal within the accessed threshold value range.

7. The touchscreen of claim 4, wherein when the processor determines that one or more sensing signals differ from the other sensing signals, the processor calculates one or more difference values of the one or more sensing signals minus one of the other sensing signals, searches the lookup table, and finds the reference value range containing the detecting signal of the environmental temperature sensor, and accesses the threshold value range corresponding to the reference value range containing the detecting signal, the processor further determines whether the one or more difference values are within the accessed threshold value range.

8. The touchscreen of claim 7, wherein when the processor determines that one of the calculated one or more difference values is within the accessed threshold value range, the processer calculates positional coordinates of a contact position on the input surface corresponding to the temperature sensor that outputs the sensing signal, which minus one of the other sensing signals acquires the difference value within the accessed threshold value range.

9. The touchscreen of claim 1, further comprising a protective film and a substrate opposing the protective film, wherein the temperature sensors are positioned on the substrate and are located between the protective film and the substrate, and a surface of the protective film facing away from the substrate acts as the input surface.

10. An electronic device, comprising:
a display device; and
a touchscreen, comprising:
an input surface;
a plurality of temperature sensors sensing temperatures of positions on the input surface and outputting corresponding sensing signals; and
a processor connected to the temperature sensors, receiving the sensing signals, and determining whether the input surface is touched based on the sensing signals.

11. The electronic device of claim 10, wherein when the processor determines that the input surface is touched, the processor further calculates positional coordinates of a contact position on the input surface and outputs the positional coordinates to the display device, the display device performs corresponding functions based on the positional coordinates.

12. The electronic device of claim 11, wherein when the processor determines that one or more sensing signals differ from other sensing signals, the processor determines that the input surface is touched and calculates positional coordinates of one or more contact positions on the input surface corresponding to the temperature sensors outputting the one or more sensing signals.

13. The electronic device of claim 11, wherein the touchscreen further comprises a storage device connected to the processor and an environmental temperature sensor connected to the processor, the environmental temperature sensor detects a current environmental temperature and outputs a corresponding detecting signal to the processor, the storage device stores a lookup table, the lookup table containing a plurality of reference value ranges that have no range overlap with each other and a plurality of threshold value ranges that have a one to one correspondence with the plurality of reference value ranges.

14. The electronic device of claim 13, wherein when the processor determines that one or more sensing signals differ from the other sensing signals, the processor searches the lookup table, finds the reference value range containing the detecting signal of the environmental temperature sensor and accesses the threshold value range corresponding to the reference value range containing the detecting signal, the processor further determines whether the one or more sensing signals are within the accessed threshold value range.

15. The electronic device of claim 14, wherein when the processor determines that one of the one or more sensing signals is within the accessed threshold value range, the processor determines that the input surface is touched and calculates positional coordinates of a contact position on the input surface corresponding to the temperature sensor outputting the sensing signal within the accessed threshold value range.

16. The electronic device of claim 13, wherein when the processor determines that one or more sensing signals differ from the other sensing signals, the processor calculates one or more difference values of the one or more sensing signals minus one of the other sensing signals, searches the lookup table, and finds the reference value range containing the detecting signal of the environmental temperature sensor, and accesses the threshold value range corresponding to the reference value range containing the detecting signal, the processor further determines whether the one or more difference values are within the accessed threshold value range.

17. The electronic device of claim 16, wherein when the processor determines that one of the calculated one or more difference values is within the accessed threshold value range, the processer calculates positional coordinates of a contact position on the input surface corresponding to the temperature sensor that outputs the sensing signal, which minus one of the other sensing signals acquires the difference value within the accessed threshold value range.

18. The electronic device of claim 10, wherein the touchscreen further comprises a protective film and a substrate opposing the protective film, the temperature sensors are positioned on the substrate and are located between the protective film and the substrate, and a surface of the protective film facing away from the substrate acts as the input surface.
